(19) United States
(12) Patent Application Publication
(10) Pub. No.: US 2008/0078464 A1
(43) Pub. Date: Apr. 3, 2008

(54) Tube system, tube including a sealing element, and method of producing an assembly unit formed of a tube and a sealing element

(75) Inventor: Hubert Loewe, Weselberg (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Electronics & Components GmbH & Co. KG

(21) Appl. No.: 11/897,123

(22) Filed: Aug. 29, 2007

(30) Foreign Application Priority Data
Sep. 15, 2006 (DE) 10 2006 043 373.4

(51) Int. Cl. F16L 47/00; B29C 45/14; F24D 3/12

(52) U.S. Cl. 138/109; 264/632

(57) ABSTRACT

A tube system, in particular for a radiant panel heating or cooling, includes a first tube (10) and a sealing element (12), the sealing element (12) being injection molded into the tube (10).

Further proposed is a tube (10) including a sealing element (12), in particular for radiant panel heating or cooling systems, producible by a two-component injection molding process, wherein at first the tube (10) made of a first plastic material is injection molded and subsequently the sealing element (12) made of a second plastic material is injection molded into the tube (10) or vice versa.

Still further, a method of producing an assembly unit formed of a tube (10) and a sealing element (12) is provided, wherein in a first step the tube (10) made of a first plastic material is injection molded, with recesses (18) being provided for the sealing element (12), and in a second step the sealing element (12) made of a second plastic material is injection molded into the tube (10), so that the tube (10) and the sealing element (12) enter into a positive and frictional connection.

### TECHNICAL FIELD

The invention relates to a tube system, in particular for a radiant panel heating or cooling, a tube including a sealing element, and a method of producing an assembly unit formed of a tube and a sealing element.

### BACKGROUND OF THE INVENTION

Tube systems including a plurality of tubes are already known from the prior art, the tubes providing sealing elements in the abutting regions, preferably sealing rings, so that the individual tubes may be sealingly connected. However, in particular in tube connections in radiant panel heating or cooling systems it is customary at present to weld the individual tubes to each other. By means of this reliable sealing type of connection the risk of leakages and of complicated and cost-intensive restorations related thereto is minimized. In order to enable a provision of the welding connections with corresponding care, the tube systems are prefabricated “made-to-order” already in the factory and transported as a complete, planar tube system to the place of installation. Apart from the complicated transport, this procedure has the disadvantage that at the place of installation existing dimensional tolerances or requests for changes can only be taken into account to a limited extent.

Therefore, it is an object of the invention to create a tube system in which individual tubes may be manufactured and connected at low expense, the tightness being reliably ensured.

### BRIEF SUMMARY OF THE INVENTION

In accordance with the invention this object is achieved by a tube system including a first tube and a sealing element, the sealing element being injection molded into the tube. By means of injection-molding of the sealing element, a very reliable sealing is provided between the first tube and the sealing element, since a good surface bond materializes between these two parts. Moreover, the sealing element cannot get lost and is fixed to exactly the desired location and does not have to be fitted to the tube manually.

Particularly preferably, the first tube and the sealing element are produced as a two-component injection molded part. Thus, with an appropriate selection of material and appropriate fashioning, it is very easily possible to non-detachably connect the first tube and the sealing element to each other. This method is for example disclosed in DE 33 40 122 A1 which is included by reference. By means of this method, it is possible in principle to have an injection molded part cured within another injection molded part such that these two parts are non-detachably connected after curing. Initially, a first injection molded part is produced in a first mold. Then, the first injection molded part is removed from the first mold and placed in a second mold. In doing so, the first injection molded part cures and gains strength to such an extent that an injection molding material may be injected into the second mold, the injection molding material filling for example openings of the first injection molded part and curing therein to form a second injection molded part.

Preferably, recesses are provided in the first tube, and protrusions complementary to the recesses are provided in the sealing element so that the first tube and the sealing element are positively connected. In addition to the surface bond this positive connection contributes to the reliability of the connection, in particular also with regard to the tightness thereof.

In one embodiment the tube system includes a second tube, the second tube being inserted into and connected to the first tube. The tube system may thus be flexibly extended or modified.

Preferably, a first latching element is provided on a wall section of the first tube, and a second latching element is provided on the second tube, the two latching elements forming a latching connection when the tubes are joined. Thus, additional tubes may reliably and sealingly be connected to an existing tube system very easily.

Moreover, the invention relates to a method of producing an assembly unit formed of a tube and a sealing element, wherein in a first step the tube made of a first plastic material is injection-molded, with recesses being provided for the sealing element, and in a second step the sealing element made of a second plastic material is injection-molded into the tube, so that the tube and the sealing element enter into a positive and frictional connection.

### BRIEF DESCRIPTION OF THE DRAWINGS

FIG. 1 shows a portion of a tube system in accordance with the invention in a perspective exploded view;

FIG. 2 shows a prefabricated component of the tube system in accordance with the invention in a perspective view;

FIG. 3 shows a detail of the tube system in accordance with the invention in a perspective view;

FIG. 4 shows a perspective detail view of a sealing element of the tube system in accordance with the invention;

FIG. 5 shows the perspective detail according to FIG. 3 along with the inserted sealing element according to FIG. 4;

FIG. 6 shows a perspective horizontal section through the detail according to FIG. 5;

FIG. 7 shows a vertical section through the detail according to FIG. 5;

FIG. 8 shows the horizontal section according to FIG. 6 along with the inserted and locked second tube; and

FIG. 9 shows the vertical section according to FIG. 7 along with the inserted and locked second tube.

### DETAILED DESCRIPTION OF THE PREFERRED EMBODIMENT

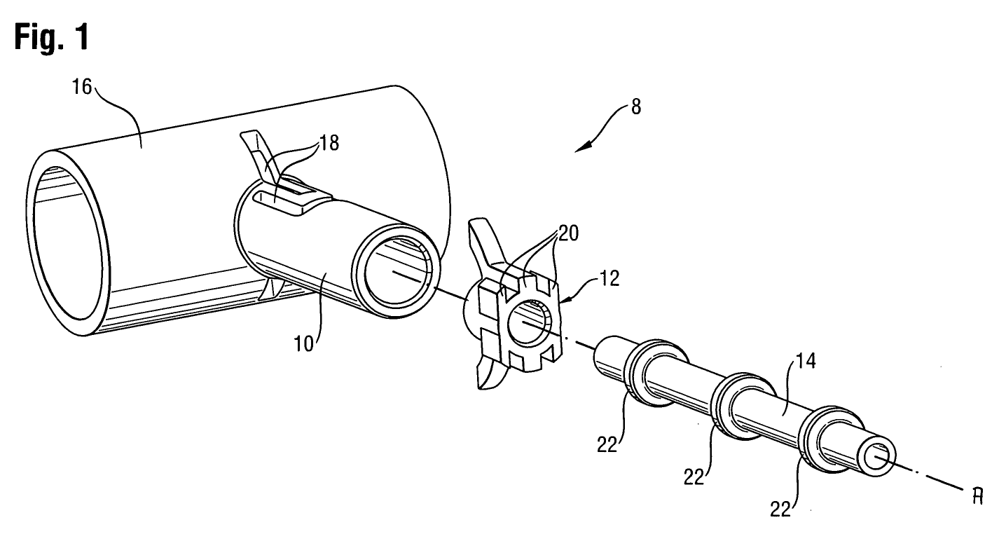

FIG. 1 shows a portion of a tube system 8, in particular for a radiant panel heating or cooling, including a first tube 10, a sealing element 12, and a second tube 14. In the present case the first tube 10 is configured as a branch of a main conduit 16, the main conduit 16 and the first tube 10 preferably being integrally connected to each other. In the present example the first tube 10 and the main conduit 16 consist of a first plastic material, for example polypropylene, and are injection molded as a one-piece part. As an alternative, it is also possible to embody the first tube 10 and the main conduit 16 as separate parts and subsequently firmly connect them to one another, for example by welding. The sealing element 12 likewise is an injection-molded plastic part, it being preferably formed of a second, soft plastic material having good sealing properties, for example a thermoplastic elastomer.

It can already be seen in FIG. 1 that the sealing element 12 has a shape which does not permit an insertion of the cured sealing element 12 into the first tube 10, respectively into the prefabricated unit of first tube 10 and main conduit 16. For this reason the sealing element 12 is immediately injection-molded into the first tube 10 and, upon curing, is non-detachably connected to the first tube 10. On the one hand, a good surface bond develops between the sealing element 12 and the first tube 10 when the material is suitably selected; on the other hand, recesses 18 are provided in the first tube 10 and protrusions 20 that are complementary thereto are provided in the sealing element 12, so that the first tube 10 and the sealing element 12 are also positively connected (see also FIG. 5).

Further visible in FIG. 1 is a part of the second tube 14 which is intended to be connected to the tube system 8, in particular to the main conduit 16. Provided on the second tube 14, which is also designated as a capillary tube, are tube protrusions 22 which in the present case are configured in the shape of flanges and extend circumferentially on the outside of the second tube 14 perpendicular to the longitudinal axis A of the tube 14.

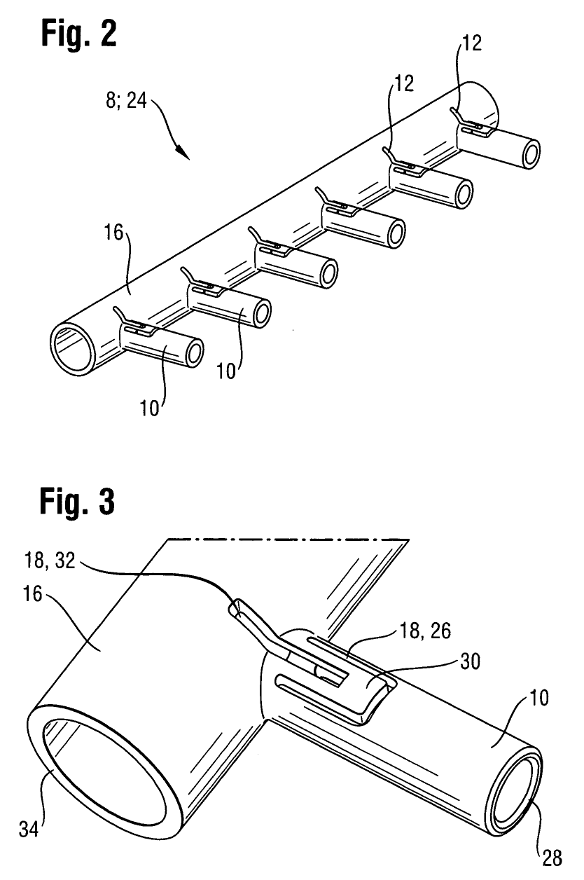

FIG. 2 shows a prefabricated component 24 of the tube system 8 which consists of a section of the main conduit 16, six first tubes 10, and six sealing elements 12. This component 24 is completely manufactured as a two-component injection-molded part.

FIG. 3 shows a connection detail of the first tube 10 to the main conduit 16. Readily visible is a U-shaped recess 26 in the first tube 10, through which a tongue-shaped wall section 30 of the first tube 10 is flexibly and elastically deformable in the radial direction in a tube wall 28. Further visible is a slot 32 which extends from the tube wall 28 of the first tube 10 into a wall 34 of the main conduit 16.

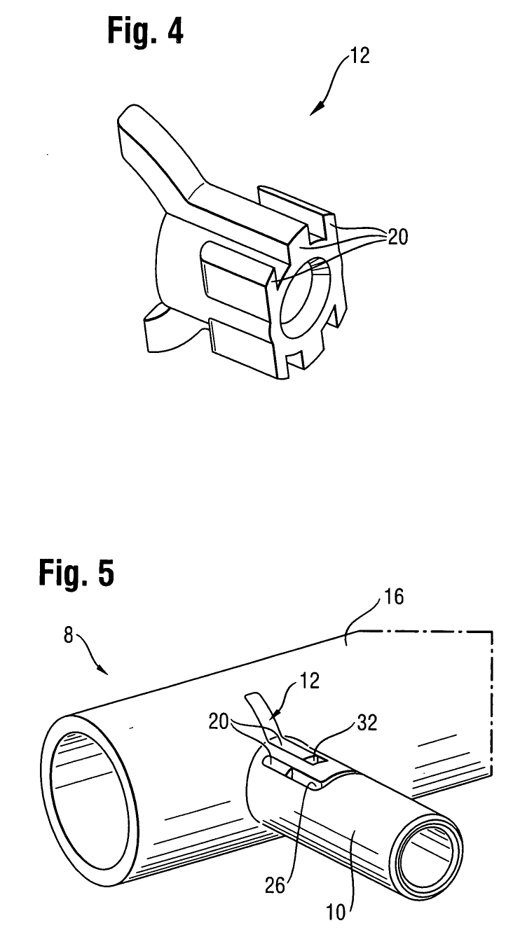

FIG. 4 shows a perspective view of the sealing element 12 which is configured as a sealing sleeve having a plurality of outside protrusions 20. Solely for reasons of illustration, the first tube 10 which surrounds the sealing element 12 was omitted. In reality, there will not be such an individual sealing element 12, since when the first tube 10 is produced, the sealing element 12 is directly injection molded into the tube. In doing so, the first tube 10 and optionally also the main conduit 16 at least partly form an injection mold for the sealing element 12.

FIG. 5 shows the connection detail of the first tube 10 to the main conduit 16 along with the injected sealing element 12. It is readily visible that the slot 32 and the U-shaped recess 26 are at least partly filled by the protrusions 20 of the sealing element 12. The non-filled regions are on the one hand caused by tools used in the injection molding process, on the other hand, however, they are also necessary to enable the tongue-shaped wall section 30 to elastically move in a radial direction, when the first tube 10 is connected to the second tube 14. Moreover, when the second tube 14 is intended to be detached, corresponding tools may engage therein, to again detach the second tube 14 from the first tube 10.

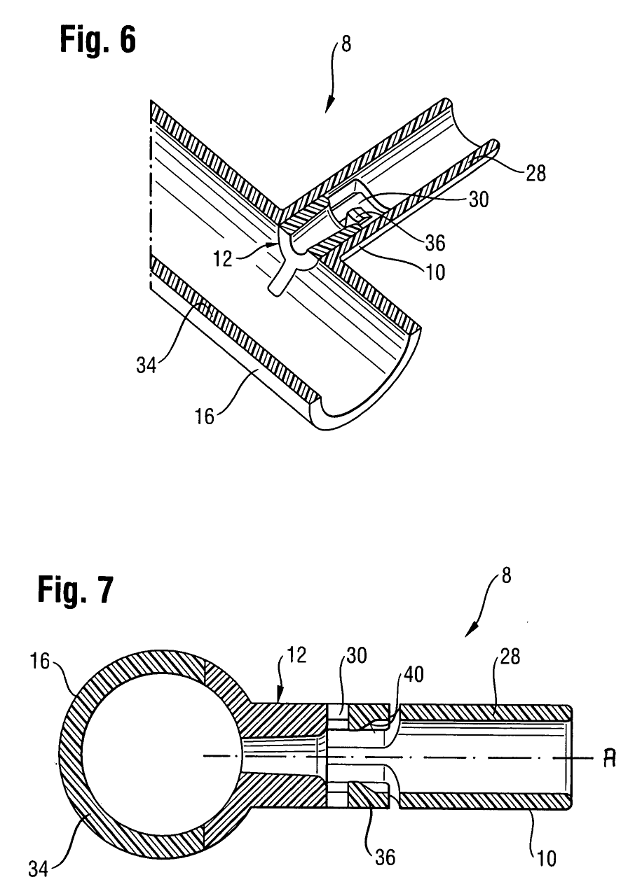

FIG. 6 shows a horizontal section through the detail of the tube system 8 according to FIG. 5. Visible in this horizontal section is a first latching element 36 which is integrally molded to the tongue-shaped wall section 30. FIG. 7 shows an associated vertical section through the detail according to FIG. 5 in a tube axis A of the first tube 10.

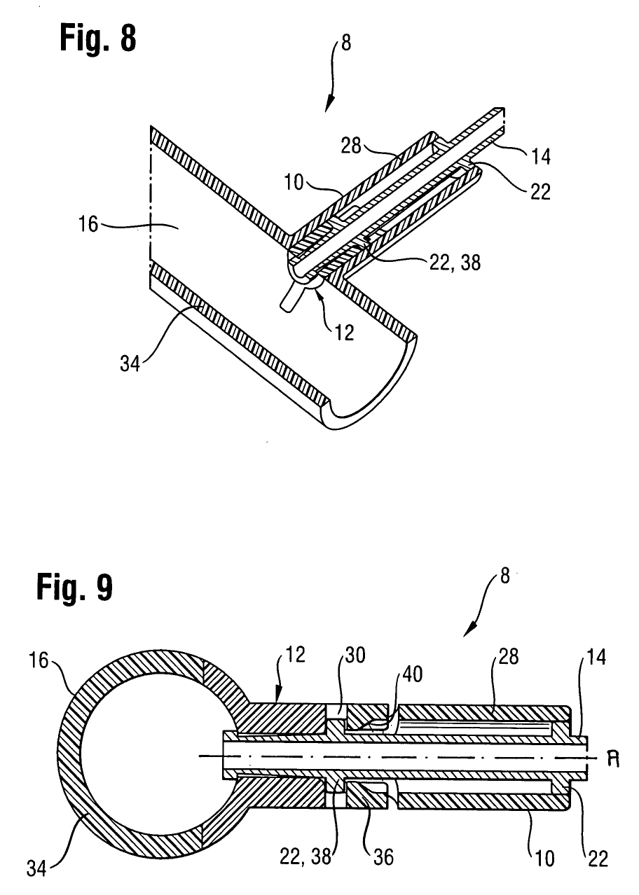

FIG. 8 shows the horizontal section according to FIG. 6, the second tube 14 being introduced into the first tube 10 and being locked with the first tube 10. Analogously, FIG. 9 corresponds to the vertical section of FIG. 7, but along with the inserted and locked second tube 14.

When the second tube 14 is introduced, that flange-type tube protrusion 22 which is closest to an axial tube end and forms a second latching element comes up against an inclined surface 40 of the first latching element 36. When the second tube 14 is further inserted towards the main conduit 16, the tube protrusion 22 slides on the inclined surface 40 so that the tongue-shaped wall section 30 moves radially outwards. Finally, the tube protrusion 22 abuts against the sealing element 12, and the tongue-shaped wall section 30 along with the first latching element 36 snaps back into its initial position. Thus, the second tube 14 is fixed to the first tube 10 in the direction of its tube axis. Preferably, the sealing element 12 is compressed to some extent on inserting the second tube 14, before the first latching element 36 snaps back into its initial position. Thereby, the sealing effect between the sealing element 12 and the second tube 14 is improved. Moreover, the second tube 14 is then mounted without play so that no rattling noises may occur between the first and second tubes 10, 14.

It is readily visible in FIGS. 8 and 9 that, as seen from the axial tube end, the second tube protrusion 22 is likewise situated inside the first tube 10. Thereby, the second tube 14 is guided in the first tube 10 in the region of its axial end and cannot become bent at right angles to its tube axis relative to the first tube 10. Accordingly, this second tube protrusion 22 of the second tube 14 can also be described as a guide element 22. The connection between the first tube 10, the sealing element 12, and the second tube 14 is thus protected against undesired stresses which otherwise could jeopardize the tightness of the connection.

1. A tube system, in particular for a radiant panel heating or cooling, including a first tube (10) and a sealing element (12), said sealing element (12) being injection molded into said tube (10).

2. The tube system according to claim 1, wherein said first tube (10) and said sealing element (12) are non-detachably connected to each other.

3. The tube system according to claim 1, wherein said first tube (10) and said sealing element (12) are produced as a two-component injection molded part.

4. The tube system according to claim 1, wherein recesses (18) are provided in said first tube (10), and protrusions (20) which are complementary thereto are provided in said sealing element (12), so that said first tube (10) and said sealing element (12) are positively connected.

5. The tube system according to claim 1, wherein said first tube (10) is a branch of a main conduit (16).

6. The tube system according to claim 5, wherein said first tube (10) and said main conduit (16) are embodied as a one-piece part.

7. The tube system according to claim 1, wherein a second tube (14) is provided, said second tube (14) being inserted into and connected to said first tube (10).

8. The tube system according to claim 7, wherein in a radial direction said sealing element (12) is situated between said first and second tubes (10, 14).

9. The tube system according to claim 7, wherein said second tube (14) includes a guide element (22) which, after connecting said first and second tubes (10, 14), is spaced away from said sealing element (12) and fixes said second tube (14) at right angles to a tube axis (A) relative to said first tube (10).

10. The tube system according to claim 1, wherein at least one wall section (30) of said first tube (10) is flexible in a radial direction and may be deformed elastically.

11. The tube system according to claim 10, wherein a first latching element (36) is provided on said wall section (30).

12. The tube system according to claim 11, wherein, after connecting said first and second tubes (10, 14), said first latching element (36) of said first tube (10) cooperates with a tube protrusion (22) of said second tube (14) and forms a latching connection.

13. The tube system according to claim 1, wherein said first tube (10) consists of polypropylene.

14. The tube system according to claim 1, wherein said sealing element (12) consists of a thermoplastic elastomer.

15. A tube (10) including a sealing element (12), in particular for radiant panel heating or cooling systems, producible by a two-component injection molding process, wherein at first said tube (10) made of a first plastic material is injection-molded and subsequently said sealing element (12) made of a second plastic material is injection molded into said first tube (10).

16. A method of producing an assembly unit formed of a tube (10) and a sealing element (12), wherein in a first step said tube (10) made of a first plastic material is injection-molded, with recesses (18) being provided for said sealing element (12), and in a second step said sealing element (12) made of a second plastic material is injection molded into said tube (10), so that said tube (10) and said sealing element (12) enter into a positive and frictional connection.
